(19) United States
(12) Patent Application Publication
(10) Pub. No.: US 2006/0279545 A1
(43) Pub. Date: Dec. 14, 2006

(54) SENSOR CHIP FOR LASER OPTICAL MOUSE AND RELATED LASER OPTICAL MOUSE

(76) Inventors: Jeng-Feng Lan, Hsin-Chu Hsien (TW); Ming-Hui Kuo, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,177

(22) Filed: Jun. 13, 2005

(51) Int. Cl. G09G 5/08

(52) U.S. Cl. 345/166

(57) ABSTRACT

A sensor chip for a laser optical module has a plurality of sensor units and a processor. The sensor units sense speckles formed on a working plane and generate image data. A distance between each of the sensors and a closest sensor is not larger than 30 micrometers. The processor processes the image data and generates a display signal, which corresponds to the movement of the laser optical mouse.

### BACKGROUND OF THE INVENTION

1. Field of the Invention

The present invention relates to a laser optical mouse, and more particularly, to a sensor chip for a laser optical mouse and related laser optical mouse.

2. Description of the Prior Art

Capable of fulfilling everything from traditional functions, such as document processing and program operation, to modern multimedia, game playing, and other functions, a personal computer (PC) has become an important device in our daily lives. Computer mice and keyboards used for controlling PCs have improved too. For example, sensing techniques that mice use to sense movement have been improved from physical wheels to optical navigation. Also, the controlling capability that mice offer have been improved from simple cursor control to a variety of fascinating functions, such as a zoom-in and zoom-out functions and a fingerprint identification function. With one finger on a mouse, a user of a computer can be in total control.

Please refer to FIG. 1, which is a bottom view of an optical mouse 10 according to the prior art. The optical mouse 10 comprises a bottom surface 12 and an opening 14 installed on the bottom surface 12. The optical mouse 10 is capable of, through the use of an LED 18 (shown in FIG. 2) used to emit light, guiding the light to travel through the opening 14 onto a working plane 40 (shown in FIG. 3) where the optical mouse 10 is placed, and of scanning and capturing images displayed on the working plane 40 and detecting any difference between two consecutive captured images. As long as the contents of the captured images change, through the use of an internal circuit, the optical mouse 10 is capable of calculating its displacement data, which can be converted into an axial displacement signal and be transmit to a computer (not shown) wirelessly or via a cable 16.

Please refer to FIG. 2, which is an inner assembly diagram of the optical mouse 10. The optical mouse 10 further comprises a light-guiding unit 20 installed above the opening 14, a circuit board 22 installed above the light-guiding unit 20, a sensor chip 24 installed on the circuit board 22, and a light source chip 26 installed on the circuit board 22. The LED 18 is installed on the circuit board 22. The sensor chip 24 comprises a plurality of sensor units disposed in the form of a matrix, and a processor for capturing images of the working plane 40 where the optical mouse 10 has been slid, and analyzing and judging the displacement of the optical mouse 10. The LED 18 acts as a light source for the sensor chip 24. The light source chip 26 is installed to fix an angle toward which the light emitted by the LED 18 travels to the light-guiding unit 20.

The light-guiding unit 20 comprises an aperture 28, a lens 30 installed in the aperture 28, a first total reflection surface 32, and a second total reflection surface 34. The circuit board 22 comprises a hole 36 installed above the lens 30 (that is above the aperture 28). The sensor chip 24 is installed on the circuit board 22 above the hole 36. The first total reflection surface 32 protrudes to a region outside of the hole 36, and is therefore disposed between the LED 18 and the sensor chip 24.

Please refer to FIG. 3, which is a side view of the inner assembly diagram of the optical mouse 10. As shown in FIG. 3, the LED 18 is opposite the first total reflection surface 34 and emits light 37. In addition, since the light source chip 26 is designed to have a shape capable of preventing the light 27 emitted by the LED 18 from directly projecting onto the light-guiding unit 20, most of the light 37 will travel toward the first total reflection surface 32 first and then be reflected downwards by the first total reflection surface 32 to the second total reflection surface 34. After being reflected by the second total reflection surface 34, the light 37 travels through the opening 14 on the bottom surface 12 and illuminates working surface 40. The working surface 40 modulates the characteristics of the light 37 and reflects the light 37 to the lens 30 to form reflected light 38. The reflected light 38 is converged and focused by the lens 30 on the sensor chip 24, and the sensor chip 24 judges the movement of the optical mouse 10 according to the change of the reflected light 38.

Since the optical mouse 10 adopts the LED 18 as the light source of the sensor chip 24, and a distance between any two optical features (e.g. stripes formed by shadows) illuminated on most parts of the working plane 40 by the light emitted from the LED 18 is larger than 30 micrometers, as long as the sensor units of the sensor chip 24 are spaced at a distance of approximately 30 micrometers, the sensor chip 24 has the capability to judge the movement of the optical mouse 10 accurately.

On the other hand, since a laser diode is designed to emit coherent laser light, which generates interference speckles through the reflection of surface details on the working plane 40, a laser optical mouse, with a laser diode as the light source, can make use of speckles formed on the working plane 40 to track more subtler surface details and to judge the mouse movement without the use of shadows. Moreover, when applying a vertical cavity surface emitting laser (VCSEL) as the light source, since the VCSEL has a low activity laser and low actuation current the laser optical mouse consumes less power than the optical mouse 10 and is favorable for wireless applications. Lastly, a laser optical mouse is approximately equal to the optical mouse 10 in size, if not smaller. In conclusion, the laser optical mouse will inevitably become the mainstream product in the mouse market.

While adopting a laser diode as the light source, prior art laser optical mice still use the sensor chip 24, in which a distance between the geometric centers of any two sensor units of the sensor chip 24 is larger than 30 micrometers. This is the case with the optical mouse 10, and it therefore lacks the capability to judge movement accurately. This is because a distance between any two speckles formed by the laser diode illuminating surface details on the working plane 40 is only about 7 micrometers long, which is far shorter than 30 micrometers.

In order to overcome the above drawback, laser optical mice, such as the optical mouse 10, include in the aperture 28 a lens to diverge the light of the speckles reflected from the working plane 40. However, the installation of the lens increases the complexity and cost of such mice.

### SUMMARY OF THE INVENTION

It is therefore a primary objective of the claimed invention to provide a sensor chip for a laser optical mouse and related laser optical mouse to overcome the above-mentioned problems.

A laser optical mouse of the present invention includes a housing; a bottom surface installed on the housing and able to be placed on a working plane; an opening installed on the bottom surface allowing light to pass through the bottom surface; a laser light source for emitting light that travels through the opening to the working plane and forms speckles on the working plane; a plurality of sensor units for sensing the speckles formed on the working plane near the opening and generating image data, each of the sensor units having a geometric center at a distance shorter than 30 micrometers from the geometric center of a nearest sensor unit; and a processor coupled to the sensor units for processing the image data generated by the sensor units and generating a display signal, the display signal corresponding to the movement of the laser optical mouse.

A sensor chip of the present invention is for a laser optical mouse, which includes a housing having a bottom surface installed thereon, the bottom surface able to be placed on a working plane. An opening is installed on the bottom surface allowing light to pass through the bottom surface. A laser light source emits light through the opening to the working plane and forms speckles on the working plane. The sensor chip includes a plurality of sensor units for sensing the speckles formed on the working plane near the opening and generating image data, each of the sensor units having a geometric center at a distance shorter than 30 micrometers from the geometric center of a nearest sensor unit. A processor coupled to the sensor units processes the image data generated by the sensor units and generates a display signal, the display signal corresponding to movement of the laser optical mouse.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a bottom view of an optical mouse according to the prior art.

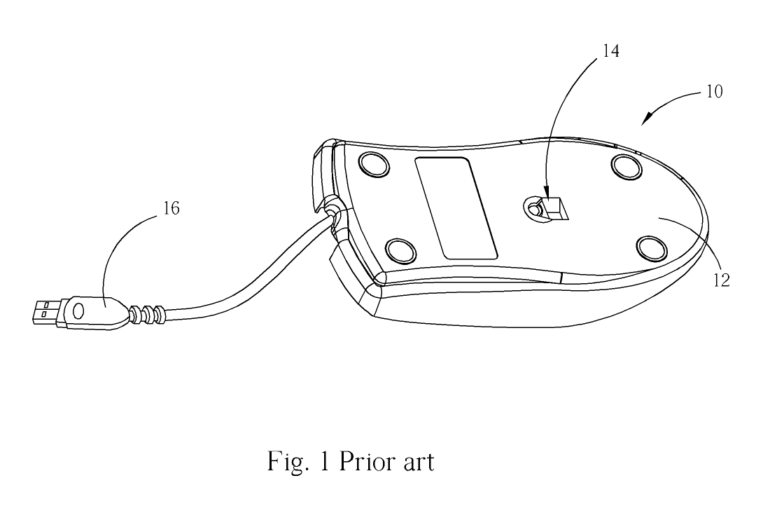

FIG. 2 is an inner assembly diagram of the optical mouse shown in FIG. 1.

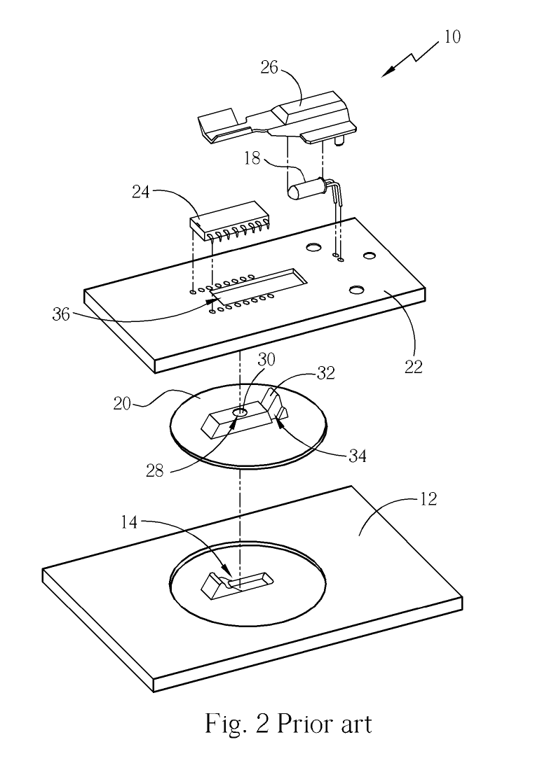

FIG. 3 is a side view of the inner assembly diagram of the optical mouse shown in FIG. 1.

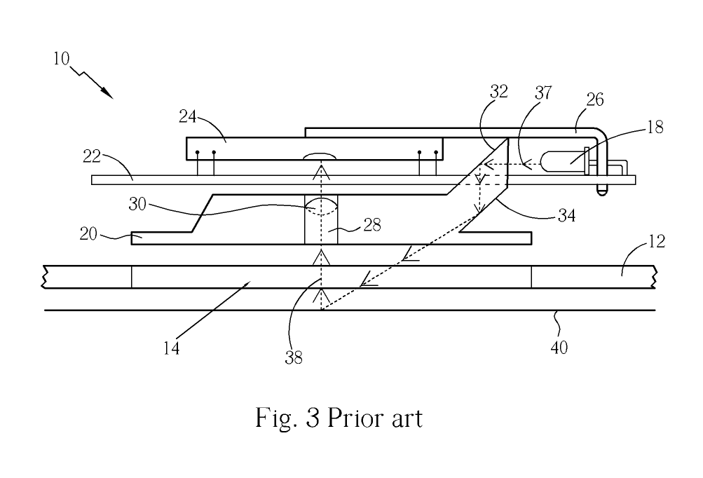

FIG. 4 is a side view of a laser optical mouse of the preferred embodiment according to the present invention.

FIG. 5 is a layout diagram of a plurality of sensor units disposed in the form of a square matrix of a sensor chip of the laser optical mouse shown in FIG. 4.

### DETAILED DESCRIPTION

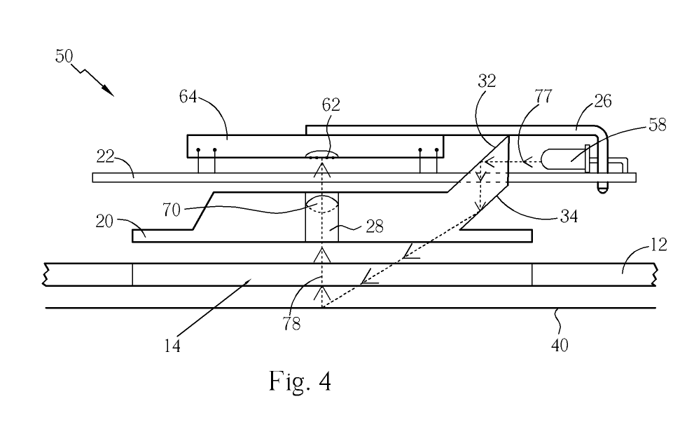

Please refer to FIG. 4, which is a side view of a laser optical mouse 50 of the preferred embodiment according to the present invention. The laser optical mouse 50, like the optical mouse 10, comprises a bottom surface 12, an opening 14, a light-guiding unit 20, a circuit board 22, a light source chip 26, and an aperture 28, but does not comprise an LED 18 or sensor chip 14. However, laser optical mouse 50 has a laser diode 58 and another sensor chip 64 instead. The sensor chip 64 comprises a plurality of sensor units 62 for sensing light, and a processor (not shown) coupled to the sensor units.

The laser diode 58 generates coherent light 77. Because the laser diode 58 is opposite the first total reflection surface 32, most of the light 77 will travel to the first total reflection surface 32 and, reflected by the first total reflection surface 32, to the second total reflection surface 34. Reflected by the second total reflection surface 34, the light 77 passes through the opening 14 of the bottom surface 12, and projects onto the working plane 40 at where the laser optical mouse 50 contacts to form speckles due to light interference on the working plane 40 near the opening 14. The working plane 40 modulates the characteristics of the light 77 and reflects the light 77 to the aperture 28 to form reflected light 78. The reflected light 78 travels to the sensor chip 64, and the sensor chip 64 determines the movement of the laser optical mouse 50 according to the variation of the reflected light 78. In detail, the sensor units 62 sense the speckles formed on the working plane 40 near the opening 14 and generate image data, and the processor processes the image data generated by the sensor units and generates a display signal, which corresponds to the movement of the laser optical mouse 50.

Of course, the light-guiding unit 20 can be omitted from a laser optical mouse of the present invention. In addition, the opening 14 of the bottom surface 12 can comprise transparent materials.

As mentioned previously, a distance between any two speckles of the surface details reflected by the laser diode 58 onto the working plane 50 is approximately equal to 7 micrometers long. To the sensor chip 64, although the distance between speckles looks longer if a distance between the sensor chip 64 and the working plane 40 increases, the distance between speckles is not larger than 30 micrometers. Thus, each of the sensor units 62 of the sensor chip 64 has a geometric center at a distance shorter than 30 micrometers from the geometric center of a nearest sensor unit. Therefore, even without installing any lens in the aperture 28, the sensor chip 64 can still identify the speckles accurately, and the laser optical mouse 50 can accurately determine its movement accordingly.

Of course, in order to determine its movement more accurately, the laser optical mouse 50, like the optical mouse 10, includes in the aperture 28 a lens 70 to diverge speckles reflected by the working plane 40.

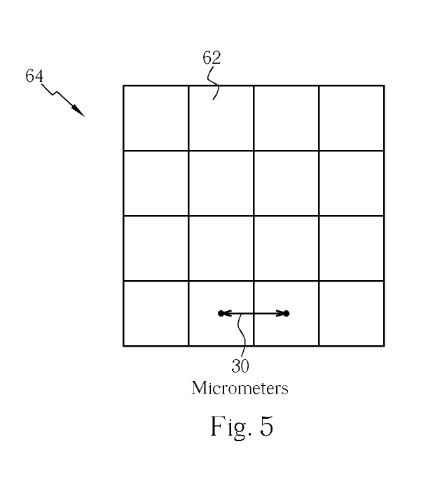

In the preferred embodiment of the present invention, the sensor units 62 of the sensor chip 64 are disposed in the form of a square matrix, as shown in FIG. 5. The sensor units 62 of the sensor chip 64 can be disposed in the form of a rectangular matrix or a matrix of another shape.

In contrast to the prior art, since each of the sensor units 62 of the sensor chip 64 has a geometric center at a distance shorter than 30 micrometers from the geometric center of a nearest sensor unit, the sensor chip 64 of the laser optical mouse 50 of the present invention has the capability to identify speckles, allowing the laser optical mouse 50 to determine its movement accurately.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A laser optical mouse comprising:
a housing;
a bottom surface installed on the housing, the bottom surface able to be placed on a working plane;
an opening installed on the bottom surface allowing light to pass through the bottom surface;
a laser light source for emitting light, the light traveling through the opening to the working plane and forming speckles on the working plane;
a plurality of sensor units for sensing the speckles formed on the working plane near the opening and generating image data, each of the sensor units having a geometric center at a distance shorter than 30 micrometers from the geometric center of a nearest sensor unit; and
a processor coupled to the sensor units for processing the image data generated by the sensor units and generating a display signal, the display signal corresponding to the movement of the laser optical mouse.

2. The laser optical mouse of claim 1, wherein the sensor units are disposed in the form of a matrix.

3. The laser optical mouse of claim 2, wherein the sensor units are disposed in the form of a square matrix.

4. The laser optical mouse of claim 2, wherein the sensor units are disposed in the form of a rectangular matrix.

5. The laser optical mouse of claim 1 further comprising a light-guiding unit for guiding the light emitted by the laser light source to the opening.

6. The laser optical mouse of claim 5, wherein the light-guiding unit comprises:
an aperture, through which the sensor units sense the speckles formed on the working plane near the opening; and
a lens for diverging speckles reflected by the working plane near the opening and projected onto the sensor units via the aperture.

7. The laser optical mouse of claim 6, wherein the lens is installed in the aperture.

8. The laser optical mouse of claim 1, wherein the laser light source comprises a laser diode.

9. A sensor chip for a laser optical mouse, the laser optical mouse comprising:
a housing;
a bottom surface installed on the housing, the bottom surface able to be placed on a working plane;
an opening installed on the bottom surface allowing light to pass through the bottom surface; and
a laser light source for emitting light, the light traveling through the opening to the working plane and forming speckles on the working plane; and
the sensor chip comprising:
a plurality of sensor units for sensing the speckles formed on the working plane near the opening and generating image data, each of the sensor units having a geometric center at a distance shorter than 30 micrometers from the geometric center of a nearest sensor unit; and
a processor coupled to the sensor units for processing the image data generated by the sensor units and generating a display signal, the display signal corresponding to the movement of the laser optical mouse.

10. The laser optical mouse of claim 9, wherein the sensor units are disposed in the form of a matrix.

11. The laser optical mouse of claim 10, wherein the sensor units are disposed in the form of a square matrix.

12. The laser optical mouse of claim 10, wherein the sensor units are disposed in the form of a rectangular matrix.
